(19) United States
(12) Patent Application Publication
(10) Pub. No.: US 2025/0299149 A1
(43) Pub. Date: Sep. 25, 2025

(54) TRAVEL INNOVATION PLATFORM

(71) Applicant: Marriott International, Inc., Bethesda, MD (US)

(72) Inventors: Naveen Manga, Germantown, TN (US); Rajesh Nair, Charlotte, NC (US); Devesh Arora, Aldie, VA (US); Suraj Saraf, Chesterfield, MO (US)

(73) Assignee: Marriott International, Inc., Bethesda, MD (US)

(21) Appl. No.: 19/085,498

(22) Filed: Mar. 20, 2025

Related U.S. Application Data
(60) Provisional application No. 63/568,647, filed on Mar. 22, 2024.

(51) Int. Cl. G06Q 10/0832; G05D 1/667; G05D 105/28; G06Q 30/0601; G06V 40/16; G07C 9/20

(52) U.S. Cl. CPC G06Q 10/0832; G05D 1/667; G06Q 30/0631; G07C 9/20; G05D 2105/285; G06V 40/172

(57) ABSTRACT

Systems and methods for a travel innovation platform are disclosed herein. The travel innovation platform can execute a method for customer fulfillment. The method includes collecting customer location information via a plurality of sensors, generating a recommendation for the customer based on the customer location and customer history, receiving a customer purchase comprising a physical item from a customer user device, and directing an autonomous vehicle to deliver the physical item to the customer. The autonomous vehicle can identify the customer based on a combination of the customer's location and an attribute of the customer determined by the autonomous vehicle.

### CROSS-REFERENCES TO RELATED APPLICATIONS

This application claims the benefit of U.S. Provisional Application No. 63/568,647, filed on Mar. 22, 2024, and entitled “TRAVEL INNOVATION PLATFORM”, the entirety of which is hereby incorporated by reference herein.

### BACKGROUND

Embodiments relate to platform for communication between multiple systems to ascertain circumstances and provide services.

### BRIEF SUMMARY OF THE INVENTION

Systems and methods for a travel innovation platform are disclosed herein. Some aspects of the present relate to a method of customer fulfillment. The method includes collecting customer information, generating a recommendation for the customer based on the customer information and customer history, receiving a customer purchase including a physical item from a customer user device, and directing an autonomous vehicle to deliver the physical item to the customer. In some embodiments, the autonomous vehicle can identify the customer based on a combination of the customer information and an attribute of the customer determined by the autonomous vehicle.

In some embodiments, collecting customer information can include collecting customer location information. In some embodiments, the method can include determining the customer location based on the customer location information collected via the plurality of sensors. In some embodiments, the plurality of sensors include a plurality of sensors forming a plurality of geofences. In some embodiments, the plurality of sensors can include an indoor positioning system (“IPS”). In some embodiments, the plurality of sensors can include a plurality of cameras coupled to a processor configured for facial recognition. In some embodiments, determining the customer location includes determining the customer location in a multilevel space.

In some embodiments, the method includes receiving a request at a physical access control from a user token for access to an access-controlled area, and determining to grant access via the physical access control based at least in part on the token and the determined customer location. In some embodiments, the token includes an application running on a customer smartphone. In some embodiments, the request at the physical access control is received directly from the user token via a wireless communication protocol. In some embodiments, the wireless communication protocol can be at least one of: Bluetooth; NFC; or Zigbee.

In some embodiments, the plurality of sensors can include at least one sensor in the access-controlled area. In some embodiments, the at least one sensor can include at least one of a light detection and ranging (“LiDAR”) sensor, an ultrasound sensor, or an ultrasonic sensor. In some embodiments, the method includes controlling an attribute of the access-controlled area via the token.

In some embodiments, the recommendation is generated based on an additional attribute of the customer detected by at least one of the plurality of sensors. In some embodiments, the method can include selecting the autonomous vehicle for delivery of the physical item. In some embodiments, the autonomous vehicle is selected based on at least one item attribute of the physical item. In some embodiments, the autonomous vehicle can include a camera. In some embodiments, the autonomous vehicle can identify the customer via facial recognition of an image generated by the camera. In some embodiments, the autonomous vehicle can identify the customer based on at least one communication between the autonomous vehicle and a user token. In some embodiments, the autonomous vehicle can include a temperature-controlled chamber configured to hold the physical item.

In some embodiments, the location information is collected via AI agent-to-agent communication. In some embodiments, the customer information is collected via communication with an AI agent. In some embodiments, the AI agent comprises a system AI agent.

One aspect relates to a method for providing a common user interface. The method includes receiving a first message in a first message format from a first computing system at an interface processor, receiving a second message in a second message format from a second computing system at a translation adapter, translating the second message from the second message format into the first message format, providing the second message from the translation adapter to the interface processor, displaying information from the first message and the second message to a user via the common user interface, receiving a user input via the common user interface, generating a first response with the interface processor for the second computing system, wherein the first response is in the first message format, and providing the first response to the second computing system.

In some embodiments, the common user interface can control an operation at each of the first computing system and the second computing system. In some embodiments, the method includes translating the first response from the first message format to the second message format with the translation adapter. In some embodiments, the translation adapter can include a virtual machine. In some embodiments, the first response can include an instruction for the second system to take an action. In some embodiments, the translation adapter can translate inbound messages to the first message format. In some embodiments, the translation adapter can translate outbound messages from the first message format to a destination format.

In some embodiments, the translation adapter can determine the destination format based on at least the recipient of the outbound message and an attribute of the outbound message. In some embodiments, translating the second message from the second message format into the first message format can include determining at least one second message input from the second message, and determining a translation key. In some embodiments, determining at least one second message input from the second message can include determining at least one of a source of the message and a destination of the second message, and identifying a message type from a message header of the second message. In some embodiments, the at least one of the source and the destination of the message are determined based on information contained in the message header of the second message.

n some embodiments, translating the second message from the second message format into the first message format further includes applying the translation key to the second message. In some embodiments, the first response is generated by the interface processor in the first message format. In some embodiments, providing the first response to the second computing system can include providing the first response to the translation adapter. In some embodiments, providing the first response to the second computing system further includes translating the first response from the first message format into the second message format, and providing the first response from the translation adapter to the second computing system.

In some embodiments, translating the first response from the first message format into the second message format includes determining at least one first response input from the first response, and determining a translation key. In some embodiments, determining at least one first response input from the first response can include determining at least one of a response source and a response destination, and identifying a message type from a message header.

In some embodiments, the translation adapter is unique to the second computing system. In some embodiments, the translation adapter can only translate between the first message format and the second message format. In some embodiments, the translation adapter can translate between a first message format and a second message format, and between a first message format and a third message format.

### BRIEF DESCRIPTION OF THE DRAWINGS

FIG. 1 is a schematic depiction of one embodiment of a central system.

FIG. 2 is a schematic depiction of one embodiment of the central system including details of an exemplary service system.

FIG. 3 is a flowchart illustrating one embodiment of a fulfillment process.

FIG. 4 is a flowchart illustrating a first portion of a process for providing a common user interface.

FIG. 5 is a flowchart illustrating a second portion of a process for providing a common user interface.

FIG. 6 a flowchart illustrating a process for providing a common user interface and for translating the first response from the first message format to the second message format is shown.

FIG. 7 is a schematic illustration of on embodiment of a computer system.

### DETAILED DESCRIPTION

Hotels have long provided hospitality services to customers. A major hallmark of quality hospitality service is the consistent quality of those hospitality services across multiple locations. At a basic level, consistent quality of hospitality services across multiple locations can be as simple as using the same bedding or furniture, but at a deeper level, providing consistency of services between locations can include providing seamless and reliable communication between multiple systems. For example, each hotel or location may have one or several systems, each of which can relate to an aspect of hospitality such as parking, rooms, cleaning, food services, entertainment, or the like. The seamless connection of these systems can greatly improve a customer experience.

Some aspects of the present relate to providing integrated services to a customer. This can include unifying services to facilitate rich and detailed transmission of information relating to a customer. This can include the generation and/or collection of location information relating to a user. This information can be collected and/or generated by one or several sensors forming a geofence and/or forming an indoor positioning system. This information can be collected and used, in connection with a customer profile, in generating a recommendation for the customer. This recommendation can be in the form of providing a recommendation for a service, a purchase, or the like.

In response to the recommendation, a customer purchase can be received. In response to this purchase, an autonomous vehicle can deliver an item corresponding to the purchase to the customer. The autonomous vehicle can identify the customer based on a combination of the customer location and an attribute of the customer. This attribute can be determined by the autonomous vehicle. This attribute can include possession of a token, which can be a physical token, a digital token, and/or a digital token associated with a physical item.

Some aspects of the present relate to the creation of seamless communication between systems and/or to the creation of a common user interface. These can be systems in a hospitality environment, or can be other systems. In some embodiments, this can include including one or several translation adapters between systems, which translation adapters can modify a message based on the source and/or destination of the message.

The translation adapter can be a physical device, or can be a virtual machine. The translation adapter can be configured to receive a message, determine a plurality of inputs relating to the message, and translate the message from an initial format to a different format selected for the destination of the message. Via the translation adapter, the common user interface can be provided for a plurality of systems some of which systems utilize different messaging formats. This can create a simplified and seamless experience as each of a number of diverse systems can be controlled via this common user interface.

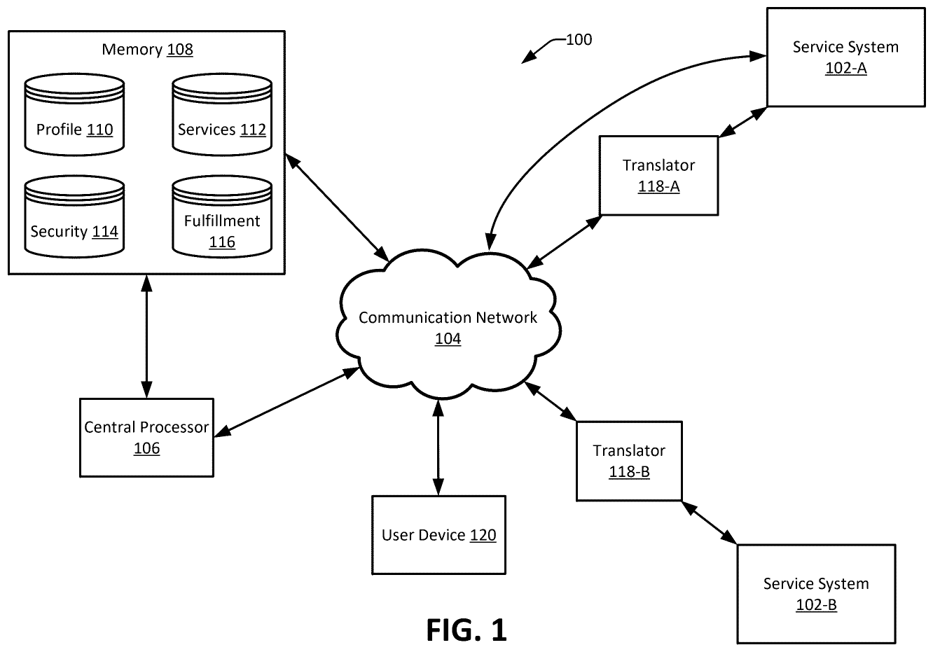

With reference now to FIG. 1, a schematic depiction of one embodiment of a central system 100 is shown. The central system 100 can be configured to link a plurality of systems that can be a plurality of service systems 102. In some embodiments, each of the service systems 102 can control aspects of the provision of one or several services to a customer. This can include the provision of one or several hospitality services. These hospitality services can include, for example, booking a room, checking-in or checking-out of a room, a room service, cleaning service, vehicle rental, equipment rental, food service, travel service, or the like.

Each of the service systems 102 are connected via a communication network 104 with a central processor 106. The communication network 104 can comprise a wired, wireless, or hybrid wired/wireless communication network 104. In some embodiments, the communication network 104 can include one or several local area networks (LAN), wide area networks (WAN), or the like. In some embodiments, the communication network 104 can include a public network including the internet, or can include a private network. Including, for example, a virtual private network.

The central processor 106 can include one or several processors, servers, computers, computing devices, or the like. In some embodiments, the central processor 106 can be a processing service provided by, for example, a cloud service provider such as Amazon Web Services, Oracle, Microsoft Azure, or the like.

In some embodiments, the central processor 106 can be configured to provide a common user interface. The common user interface can provide a user interface via which a user can interact with the service systems 102.

In some embodiments, the central processor 106 can communicate via a first messaging format. In some embodiments, some of the service systems 102 can communicate via the first messaging format, and some of the service systems 102 can communicate via other messaging formats such as, via a second messaging format. In some embodiments, and via these different messaging formats, the central processor 106 cannot communicate with some or all of the service systems 102, and specifically the central processor 106 cannot communicate with service systems 102 that communicate via a message format other than the first message format.

The central system 100 can include memory 108. The memory 108 can include physical memory or memory in the cloud. The memory 108 can include one or several instructions executable by the central processor 106. These instructions, when executed by the central processor 106 can cause the central processor 106 to take one or several actions, some of which actions will be discussed at greater length below.

The memory 108 can include one or several databases 110-116. These databases 110-116 can store information received by the memory 108. These databases 110-116 can include, for example, a profile database 110, a services database 112, a security database 114, and a fulfillment database 116. In some embodiments, the profile database 110 can include information relating to customers. This information can include one or more customer profiles. In some embodiments, a customer profile can be unique to a customer, and can include information relating to the customer. This information can include, for example, information identifying attributes of the customer. The information in the profile database 110 can include information relating to one or several customer preferences including, for example, view preferences, room preferences, travel preferences, food preferences, service preferences, or the like. The profile database 110 can include information relating to one or several customer actions, and specifically relating to one or several customer action within a location such as a hotel. This information can include, for example, with the customer's permission, information relating to customer location, customer movement, customer movement patterns, or the like. In some embodiments, this information can be stripped of any privacy-related information, or in other words, can be stripped of PII or anonymized. This information can be collected and stored in a secure manner and in compliance with requirements and regulations for collection and storage of any privacy-related information.

The services database 112 can include information relating to provided services and/or to available services. This can include information such as, for example, room booking, room check-in and/or check-out, room cleaning, food services, purchases, or the like. In some embodiments, the services database 112 can further include information relating to one or several payments made by customers.

The security database 114 can include security information. This can include, for example, information relating to access rights. These access rights can define the ability of one or several customers, users, and/or employees to access locations, to control certain functions, or the like. By way of example, in some embodiments, the access rights can define a customer as having access to the customer's room, access to a hotel gym, access to the pool, and access to a business center. In some embodiments, this access can be unrestricted, and in some embodiments, this access can be restricted. For example, a customer may have unrestricted access to their room, but may only have access to an area and/or facility during certain times. More specifically, a customer may only have access to the hotel pool when the pool is open.

The security information can include information relating to ability to control one or several functions. For example, the security information can define a user's ability to control one or more features within a location. For example, this can include defining a customer's ability to control a room temperature, room lighting, blinds, or the like.

The fulfillment database 116 can, in some embodiments, include information relating to delivery of one or more services and/or fulfilling one or several purchases. This can include information that is customer specific and/or information that is non-customer specific. In some embodiments, the fulfillment database 116 can further include information relating to customer satisfaction with fulfillment.

As further seen in FIG. 1, in some embodiments, some or all of the service systems 102 are connected to the central processor via one or several translator adapters 118. In some embodiments, the translator adapter 118 can intercept message traffic between the service system 102 and the central processor 106 and can modify the format of those messages such that the recipient of the message can read and/or understand the message. Details of the translation adapters 118 will be discussed at length below.

In some embodiments, the central system 100 can be communicatingly coupled to a user device 120. The user device 120 can comprise any computing device such as, for example, a smartphone, a computer, a laptop, a personal computer, a server, a tablet, a PDA, one or more servers, one or more processors, or the like. In some embodiments, the user device 120 can be communicatingly coupled to the central system 100 such that the central system 100 can receive information and/or inputs from the user device 120 and/or provide information and/or outputs to the user device 120.

In some embodiments, the user device 120 can comprise one or more AI agents. The one or more AI agents can comprise a trained AI model configured to act on behalf of the user and/or to complete one or more tasks and/or take one or more actions on behalf of the user. In some embodiments, the one or more AI agents can communicate with the central system 100. This communication can be direct and/or via one or more AI agents of the central system 100, also referred to herein as system AI agents. In some embodiments, the one or more system AI agents can access one or more systems within the central system 100 and/or take one or more action within the central system 100.

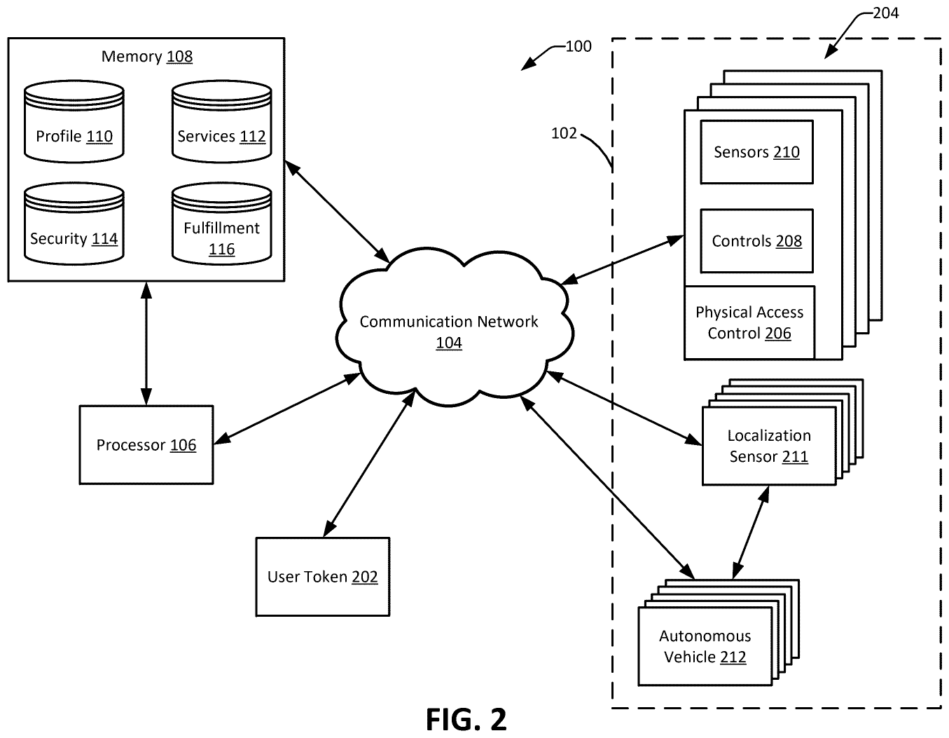

With reference now to FIG. 2, a schematic depiction of one embodiment of the central system 100 including details of an exemplary service system 102 is shown. As seen, the central system includes the service system 102, the communication network 104, the central processor 106, and the memory 108. Additionally, the central system 100 can further include the user token 202. The user token 202 can be a physical token, a digital token, and/or a digital token associated with a physical item. For example, in some embodiments, the user token 202 can be a key, a key card, a smartphone, a smartwatch, or the like. In some embodiments, the user token 202 can comprise a feature containing information that can be used to identify the token 202, and which information can be communicated to one or several devices such as one or several querying devices. In some embodiments, the token 202 can include one or several features configured to allow wireless communication of this information associated with the token 202. These features can include, for example, an antenna, a processor, memory, a transceiver, a power source, a Radio Frequency Identification (RFID) tag, or the like. In some embodiments, the token comprises an application running on a customer device such as a smartphone or a smartwatch.

As further seen in FIG. 2, the service system 102 includes a plurality of features and/or components. In some embodiments, the service system 102 can include one or several access-controlled areas 204. These access-controlled areas 204 can comprise one or several rooms, locations, or the like.

In some embodiments, each of the access-controlled areas 204 can comprise a physical access control 206. The physical access control 206 can comprise a feature configured to interact with the token 202 and to determine access based on the token 202. In some embodiments, the physical access control 206 can comprise one or several communication features configured to interact with the token, one or several communication features configured to retrieve information from the memory 108 and specifically from the profile database 110 and/or the security database 114, and/or one or several locking features.

The access-controlled areas 204 can include one or several controls 208. These can include controls 208. These controls 208 can include controls of features in the access-controlled area 204 and/or of an attribute of the access-controlled area 204. These controls 208 can include, for example, thermostat, light switch, blind/curtain control, television control, or the like. In some embodiments these controls can be configured to link with the token to verify the token and thereby the customer, and to then be controllable via the token 202. In some embodiments, for example, in which the token 202 comprises an app on a device, the user can control the controls 208 via the app.

The access-controlled area 204 can include one or several sensors 210. The one or several sensors 210 can be configured to determine one or several attributes of the access-controlled area 204. This can include, determining the location and/or movement of the user in the access-controlled area, determining status of the access-controlled area 204, or the like. In some embodiments, these sensors can comprise, for example, at least one of: a light detection and ranging (“LiDAR”) sensor, an ultrasound sensor, or an ultrasonic sensor. In some embodiments, and based on information generated by the sensors 210, a state of the access-controlled area 204 can be determined. This state can include, for example, whether a room has been cleaned, a bed has been made, trash has been emptied, or the like.

The service system 102 can further include one or several localization sensors 211. The one or several localization sensors 211 can be configured to determine, identify, and/or track a location of an individual in a building or area such as in a hotel. In some embodiments, these sensors can be configured to determine the location of an individual via interaction with a user token. This can include, for example, one or several geofence sensors configured to determine when the user token and the thereby associated user moves into a geofenced area and/or location. The sensors 210 can, in some embodiments, include one or several sensors comprising an indoor positioning system (IPS). In some embodiments, the IPS can be configured to determine a location of an individual in a limited space, which limited space can, in some embodiments be in a hotel, on the hotel grounds, or the like. In some embodiments, the localization sensors 211 can comprise one or several cameras coupled to a processor configured for facial recognition. In some embodiments, the localization sensors 211 can be configured to determine the location of an individual within a multilevel space. This determination can include determining the location of an individual within a hotel having many floors.

As seen in FIG. 2, the service system 102 can include one or several autonomous vehicles 212. The one or several autonomous vehicles 212 can include a vehicle that is self-controlled and configured to deliver a physical item or an experience to an individual. The autonomous vehicle 212 can include a driving vehicle, a flying vehicle, water-borne vehicle, or the like. In some embodiments, the autonomous vehicle can comprise a wheeled vehicle, a treaded vehicle, a flying drone such as a fixed-wing drone or a rotary wing drone, a boat, or the like.

In some embodiments, the autonomous vehicle 212 can be configured to deliver an item to an individual. As such, the autonomous vehicle 212 can be configured to receive information indicating the location of the individual and information to identify the individual. In some embodiments, this can include receiving information relating to the token 202, to the appearance of the individual, to biometrics of the individual, or the like. In some embodiments, the autonomous vehicle 212 can include one or several features to facilitate in identifying the individual, and thus, in some embodiments, the autonomous vehicle 212 can include a camera, one or several features configured to communicate with the token 202, or the like. In some embodiments, for example, the autonomous vehicle 212 can use the camera to identify an individual via facial recognition.

In some embodiments, the autonomous vehicle can include one or several chambers for holding the item being delivered. In some embodiments, these one or several chambers can be temperature controlled. This can include these one or several chambers being heated and/or cooled.

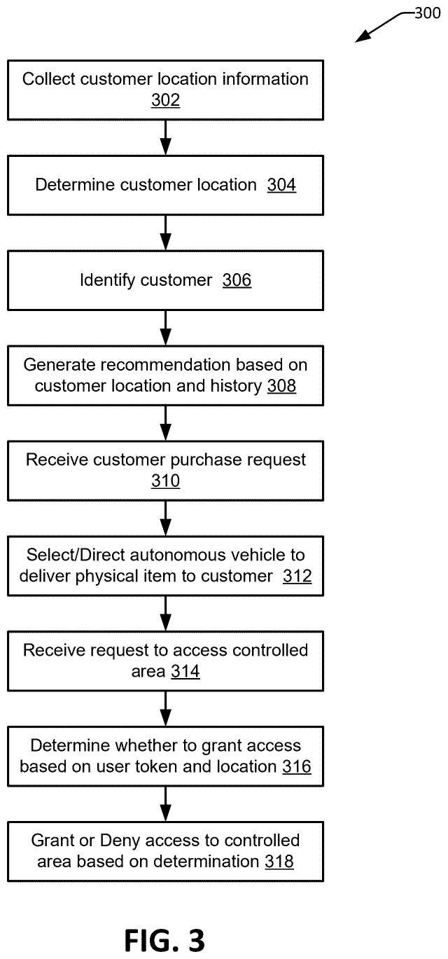

With reference now to FIG. 3, a flowchart illustrating one embodiment of a process 300 for fulfillment is shown. The process can be performed by all or portions of the central system 100 depicted in FIG. 1 or in FIG. 2. In some embodiments, steps of the process 300 can be performed by a service system 102 and/or by components of the service system 102. In some embodiments, the service system can, as depicted in FIGS. 1 and 2, communicate with the central processor 106 and/or utilize information received from the central processor 106. In some embodiments, some or all of the steps of the process 300 can be performed using the common user interface as will be discussed at greater length below.

The process 300 begins at block 302. wherein customer location information is collected. In some embodiments, the customer location information can be collected by one or more of the localization sensors 211, which can be a plurality of sensors. In some embodiments, the customer location information can be further collected by sensors 210 can be located in one of the access-controlled areas 204. In some embodiments, customer location information can be collected by sensors comprising a geofence, sensors comprising an indoor positioning system, one or several cameras coupled to a processor configured for facial recognition, or the like. In some embodiments, the collection the customer location information can be based on interactions of one or more of the sensors 210 and/or localization sensors 211 with the customer token 202 and/or when a customer device such as a smartphone or smartwatch. This location information can be provided by the sensors 210, 211 to a processor such as the central processor 106.

And step 304, a customer location is determined. In some embodiments, this customer location can be the current location of the customer. This customer location can be determined based on the collective customer location information from step 302. In some embodiments, determining the customer location can include determining that the customer is in one or several areas such as in one or several geofenced areas, determining the customer location in one or several of those one or several areas including determining the customer's location in the geofenced area, determining the customer location in a multilevel an/or three-dimensional space, or the like. In some embodiments, this determination can be performed by a processor such as the central processor 106.

At block 306, the customer is identified. In some embodiments, this can include linking customer location information and/or the customer location to a customer and specifically to a customer identifier. In some embodiments, this identifying of the customer can be performed by a processor such as the central processor 106.

At block 308, a recommendation is generated for the customer based on the customer location in the customer history. In some embodiments, this customer history can be determined based on the customer profile. In some embodiments, this recommendation can be generated by the central processor 106 based on information retrieved from the memory 108 and specifically from the profile database 110. In some embodiments, customer location and information from the customer profile can be ingested into the machine learning model which can generate the recommendation. In some embodiments, the machine learning model can include generative AI which can generate the recommendation and can generate a vehicle for communicating that recommendation. In some embodiments, the generative AI can comprise an AI agent. This vehicle for communicating the recommendation can include a picture, video, sound including voice or music, or the like.

In some embodiments, the recommendation can be generated based on one or more additional attributes of the customer detected by at least one of the plurality of sensors 210, 211. These one or more additional attributes of the customer can include, for example, information relating to people traveling with the customer such as the customer is traveling with children. In some embodiments, the recommendation can be generated based on information received via at least one AI agent. In some embodiments, for example, a user AI agent can interact with the system AI agent to provide information to the system relating to one or more requests of the user. Alternatively, in some embodiments, the system can interact with a user AI agent to collect user information, or the user can interact with a system AI agent to collect user information. In some embodiments, this can include, for example, providing information such as information collected in steps 302, 304, and/or 306 and/or requesting, ordering, and/or purchasing one or several items and/or services.

At block 310, a customer purchase request is received. In some embodiments, this purchase request can be for physical item or for a service. In some embodiments, this customer purchase request can be received from the customer via the customer device such as via the customer's smartphone, smartwatch, or other computing device, and in some embodiments, the purchase request can be received via customer interaction with the device of the service system 102. In some embodiments, and as part of receiving the purchase request, the purchase can be transacted via one or several interactions with one or several payment processors. In some embodiments, the customer purchase request can be received by the central processor 106. In some embodiments, this payment can be transacted and/or processed according to government and/or industry standards and/or regulations.

At block 312 on autonomous vehicle is selected for delivering the purchased item to the customer and the autonomous vehicle is directed to deliver the purchased item to the customer. In some embodiments, the autonomous vehicle can be selected based on a location of the customer such that the autonomous vehicle is able to access that location and deliver the purchased item to the customer. For example, in an embodiment in which the customer is on a boat, and autonomous vehicle such as a flying or waterborne autonomous vehicle will be selected.

In some embodiments, the autonomous vehicle can be selected based on at least one attribute of the purchased item. This can include, for example, a size of the purchased item, a weight of the purchased item, delivery conditions for the purchased item, or the like. In some embodiments, delivery conditions for the purchased item include, for example, a desired temperature of the delivered item.

In some embodiments, directing the autonomous vehicle to deliver the item to the customer can include providing customer location information to the autonomous vehicle. In some embodiments, this can be a one-time transfer of information, and in some embodiments, this can include providing updated location information to the autonomous vehicle such that if the customer changes the location the economist vehicle can still deliver the purchased item. In some embodiments, the autonomous vehicle can subscribe to receive real-time updates to the customer location and/or to receive real-time customer location information.

The autonomous vehicle can deliver the item to the customer, which can include transporting the item to the customer location and identifying the customer before releasing the item to the customer. In some embodiments, the autonomous vehicle can be configured to identify the customer based on a combination of the customer's location and an attribute of the customer, which attribute can be determined by the economist vehicle. In some embodiments, the autonomous vehicle can be configured to identify the customer based on at least one communication between the autonomous vehicle and the token 202.

At block 314 a request for access to an access-controlled area 204 is received. In some embodiments the request for access can include an interaction between the user token 202 in the physical access control 206. In some embodiments, the physical access control 206 can, based on the interaction with user token 202, identify the user. In some embodiments, the request for access can be received by the physical access control 206 directly from the user token 202 via wireless communication between the physical access control 206 and the user token 202. In some embodiments, this wireless communication can be according to a wireless communication protocol. In some embodiments, this wireless communication protocol can be at least one of, Bluetooth, NFC, or Zigbee.

Based on information received from the token 202 it can be determined whether to grant access to the customer as indicated at block 316. In some embodiments, this determination can be made based on the user token 202 and the location of the user. In some embodiments, and as part of this determination, the physical access control 206 can communicate with the processor 106 and/or with the memory 108 to either receive the determination of whether to grant access or to receive information to make the determination of whether to grant access. In some embodiments, for example, the physical access control 206 can provide information received from the token 202 to the processor 106 and the processor 106 can determine whether to grant access based on that information along with information from the memory 108 and specifically from the security database 104. Alternatively, the physical access control 206 can query the memory 108 for security information from the security database 114. Upon receipt of this information, the physical access control 206 can determine whether to grant access.

At block 318, access is granted or denied to the access-controlled area based on the determination of block 316. If it is determined that access is granted, then the physical access control 206 can allow access to access-controlled area 204 via, for example, unlocking the door. If it is determined that access is denied, the physical access control 206 can prevent access to the axis-controlled area 204 via, for example, maintaining the door in a locked configuration.

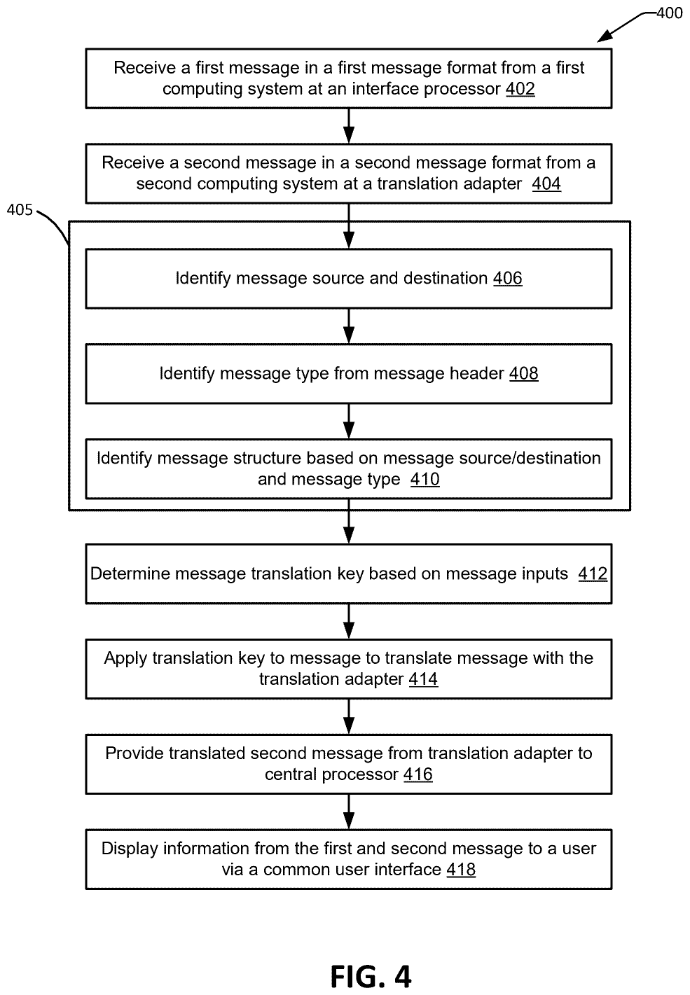

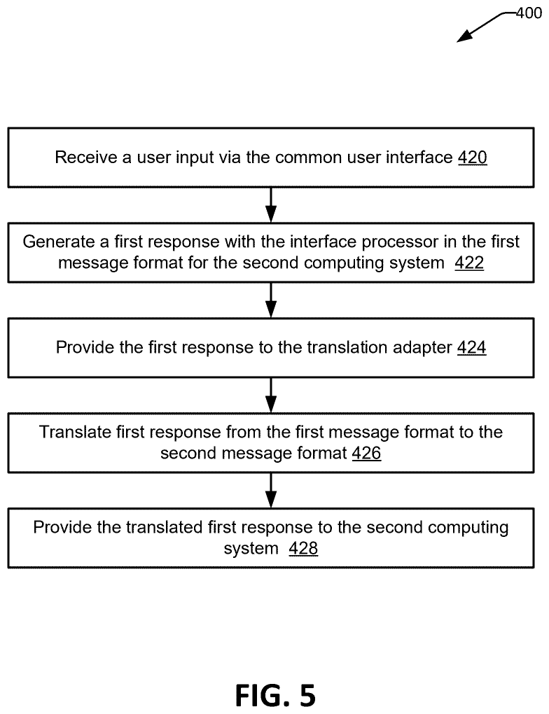

With reference now to FIGS. 4 and 5 a flowchart illustrating one embodiment of a process 400 for providing a common user interface is shown. In some embodiments, the common user interface is configured to control an operation of different components of the system 100, or in other words, via the common user interface operation of all or portions of each of a first service system 102-A and a second service system 102-B can be controlled.

The process 400 can be performed by all or portions of the central system 100 depicted in FIG. 1 or in FIG. 2. In some embodiments, the process 400 can be performed in connection with process 300 such that communications between components of the system 100 depicted in FIG. 1 or in FIG. 2 utilize all or portions of the process 400.

The process 400 begins at block 402 wherein a first message in the first message format is received from a first computing system at the central processor 106, also referred to herein as the interface processor 106. In some embodiments, this first computing system can be the first service system 102-A. In some embodiments, the central processor 106 can be configured to communicate via the first message format, and thus, the first message in the first message format from the first service system 102-A can travel directly from the first service system 102-A to the central processor 106 without first passing through the translation adapter 118 as indicated in FIG. 1 by the curved arrow directly connecting service system 102-A to the communication network 104.

At block 404 a second message and a second message format are received from a second computing system such as the second service system 102-B at a translation adapter 118, and specifically at the second translation adapter 118-B. In some embodiments, the translation adapter 118 can be a physical device, and in some embodiments, the translation adapter 118 can be a virtual machine. In some embodiments, the translation adapter 118 can be virtual machine operating within a container.

In some embodiments, the translation adapter 118 can be configured to translate messages from one format to another format. This can include translating inbound messages destined for the central processor 106 to the first format and translating outbound messages destined for the system using a messaging format other than the first format to that messaging format other than the first format. In other words, the translation adapter can be configured to translate outbound messages from the first message format to a destination format, or in other words to a message format compatible with the destination system. In some embodiments, the translation adapter 118 can be configured to determine the destination format based on at least a recipient of the outbound message and an attribute of the outbound message.

In some embodiments, the translation adapter 118 can be unique to the second computing system, or in other words, the translation adapter 118 can be in a one-to-one relationship with the second computing system. In some embodiments, the translation adapter 118 can be shared by multiple computing systems. In some embodiments, the translation adapter 118 can be configured to only translate between two message formats, or specifically to translate between the first message format and the second message format. In some embodiments, the translation adapter can be configured to translate between more than two message formats, or specifically to translate between the first message format in the second message format, and to translate between a first message format and the third message format.

At block 405 inputs are extracted from the second message by the translation adapter 118. These inputs can identify one or several features of the second message. These inputs can be, in some embodiments, identified in the message itself, identified in the header of the message, and/or identified in a payload of the message.

Block 406 through 410 depict steps in extracting inputs. In some embodiments, some or all of the steps of block 406 through 410 can be performed as a part of the step of block 405. At block 406 a message source and/or destination is identified. In some embodiments, the message source and destination can be determined based on information contained in the message and specifically contained in the message header. In some embodiments, the step of block 406 can include decapsulating the received message and extracting the header of the message. In some embodiments, the header can contain information identifying the source of the message, which information can specify a source IP address, and/or the header can contain information identifying the destination of the message, which information can specify a destination IP address. Thus, in some embodiments, at least one of the source and the destination of the message can be determined based on information contained in the message header of the second message.

At block 408 a message type is determined. In some embodiments the message type can characterize aspects of the message including, for example, which information is contained in the message, the effect of receipt of the message, or the like. In some embodiments, the message type can be specified in the header of the message.

At block 410, message structure is identified. In some embodiments, the message structure can be identified based on a combination of the message source and destination and the message type. In some embodiments, the message structure can characterize how the payload of the message is structured including, which fields are found in the payload.

At block 412 a message translation key is determined based on the message inputs. In some embodiments, this can include ingesting the message inputs into a model configured to identify the translation key based on the message inputs. In some embodiments, and based on the message inputs, the translation adapter 118 can determine the translation key either alone, or in connection with other components of the system 100.

At block 414 the translation key is applied to the second message by the translation adapter 118 to translate second message from the second message format to the first message format. In some embodiments, this can include translating all or portions of the second message. This can include merging fields, splitting fields, modifying fields, or the like.

At block 416, the translated second message is provided from the translation adapter 118 to the central processor 106. In some embodiments, the translate second message can be provided from the translation adapter 118 to the central processor via the communication network 104.

The translated second message is received by the central processor 106, and as indicated in block 418 information from the first and second messages is provided to the user via the common user interface. In some embodiments, the common user interface can be controlled by the central processor 106, and/or the central processor 106 can control the providing of information for display via the common user interface.

Continuing to FIG. 5, at block 420 a user input is received via the common user interface. At block 422, a first response is generated with the central processor 106 based on the received user input. In some embodiments, the first response can include an instruction for the second computing system, or in other words for the second service system 102-B to take an action. In some embodiments, this first response is generated by the central processor 106 in the first message format and has an intended destination of the second computing system, or in other words an intended destination of the second service system 102-B.

At block 424 the first response is sent by the central processor 106 with the destination of the second service system 102-B. However, before arriving at the second service system 102-B, the first response is received by the translation adapter 118 position between the central processor 106 and the second service system 102-B. Thus, in some embodiments, although the first response is sent by the central processor 106 to the second service system 102-B, the first response is provided to the translation adapter 118.

At block 426, the first response is translated from the first message format to the second message format. In some embodiments, this translation can be performed by the translation adapter 118. At block 428, the translated first response is provided to the second computing system, or in other words, the second service system 102-B.

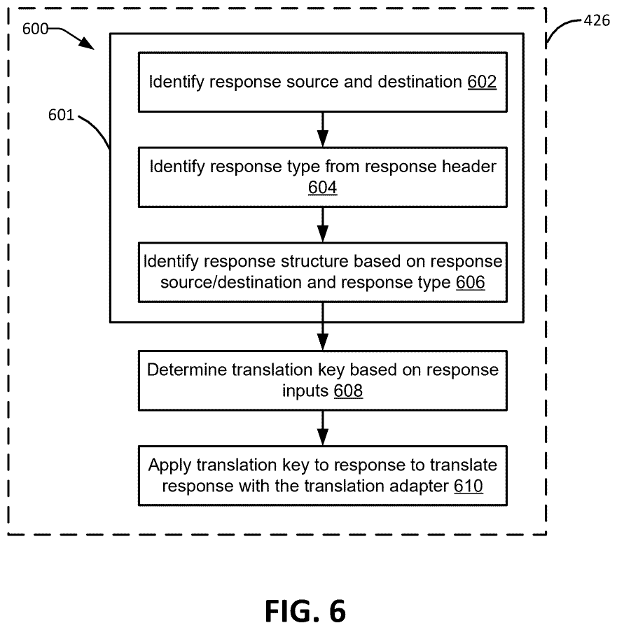

With reference now to FIG. 6, a flowchart illustrating one embodiment of a process 600 for providing a common user interface and for translating the first response from the first message format to the second message format is shown. In some embodiments, the process 600 can be performed as a part of or the place of the step of block 426.

The process 600 starts at block 601, wherein inputs are extracted from the first response by the translation adapter 118. These inputs can identify one or several features of the first response. These inputs can be, in some embodiments, identified in the response itself, identified in the header of the response, and/or identified in a payload of the response.

Block 602 through 606 depict steps in extracting inputs. In some embodiments, some or all of the steps of block 602 through 606 can be performed as a part of the step of block 601. At block 602 a response source and/or response destination is identified. In some embodiments, the response source and response destination can be determined based on information contained in the first response and specifically contained in the response header. In some embodiments, the step of block 602 can include decapsulating the received response and extracting the header of the response. In some embodiments, the header can contain information identifying the source of the response, which information can specify a source IP address, and/or the header can contain information identifying the destination of the response, which information can specify a destination IP address. Thus, in some embodiments, at least one of the source and the destination of the response can be determined based on information contained in the response header of the first response.

At block 604 a response type is determined. In some embodiments the response type can characterize aspects of the first response including, for example, which information is contained in the response, the effect of receipt of the response, or the like. In some embodiments, the response type can be specified in the header of the response.

At block 606, response structure is identified. In some embodiments, the response structure can be identified based on a combination of the response source and response destination and the response type. In some embodiments, the response structure can characterize how the payload of the response is structured including, which fields are found in the payload.

At block 608 a response translation key is determined based on the response inputs. In some embodiments, this can include ingesting the response inputs into a model configured to identify the translation key based on the response inputs. In some embodiments, and based on the response inputs, the translation adapter 118 can determine the translation key either alone, or in connection with other components of the system 100.

At block 610 the translation key is applied to the first response by the translation adapter 118 to translate first response from the first message format to the second message format. In some embodiments, this can include translating all or portions of the first response. This can include merging fields, splitting fields, modifying fields, or the like.

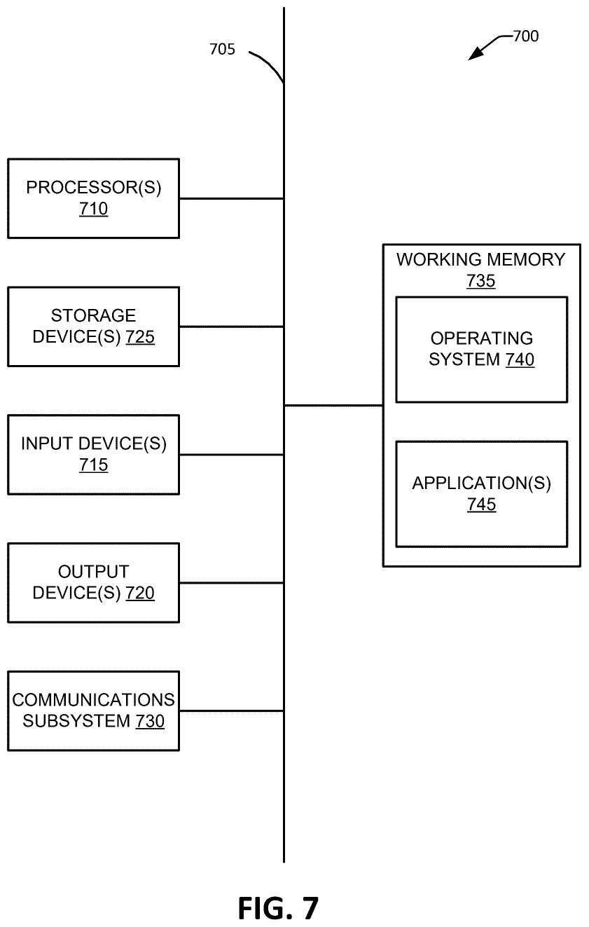

With reference now to FIG. 7, a computer system may be incorporated as part of the previously described computerized devices. For example, computer system 700 can represent some of the components of system 100, processor 106, and/or other computing devices described herein. FIG. 7 provides a schematic illustration of one embodiment of a computer system 700 that can perform the methods provided by various other embodiments, as described herein. FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include a processing unit 710, including without limitation one or more processors, such as one or more special-purpose processors (such as digital signal processing chips, graphics acceleration processors, and/or the like); one or more input devices 715, which can include without limitation a keyboard, a touchscreen, receiver, a motion sensor, an imaging device, and/or the like; and one or more output devices 720, which can include without limitation a display device, a speaker, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 700 might also include a communication interface 730, which can include without limitation a modem, a network card (wireless or wired), an infrared communication device, a wireless communication device and/or chipset (such as a Bluetooth™ device, a 502.11 device, a Wi-Fi device, a WiMAX device, an NFC device, cellular communication facilities, etc.), and/or similar communication interfaces. The communication interface 730 may permit data to be exchanged with a network (such as the network described below, to name one example), other computer systems, and/or any other devices described herein. In many embodiments, the computer system 700 will further comprise a non-transitory working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 710, applications 745, etc.) Further, connection to other computing devices such as network input/output devices may be employed.

Some embodiments may employ a computer system (such as the computer system 700) to perform methods in accordance with the disclosure. For example, some or all of the procedures of the described methods may be performed by the computer system 700 in response to processing unit 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the storage device(s) 725. Merely by way of example, execution of the sequences of instructions contained in the working memory 735 might cause the processing unit 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processing unit 710 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 725. Volatile media include, without limitation, dynamic memory, such as the working memory 735. Transmission media include, without limitation, coaxial cables, copper wire, and fiber optics, including the wires that comprise the bus 705, as well as the various components of the communication interface 730 (and/or the media by which the communication interface 730 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a non-transitory storage device 725 either before or after execution by the processing unit 710.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

The methods, systems, devices, graphs, and tables discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein, including in the claims, “and” as used in a list of items prefaced by “at least one of’ or “one or more of’ indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

1. A method of customer fulfillment comprising:
collecting customer information;
generating a recommendation for the customer based on the customer information and customer history;
receiving a customer purchase comprising a physical item from a customer user device; and
directing an autonomous vehicle to deliver the physical item to the customer, wherein the autonomous vehicle is configured to identify the customer based on a combination of the customer's information and an attribute of the customer determined by the autonomous vehicle.

2. The method of claim 1, wherein collecting customer information comprises collecting customer location information, the method further comprising determining the customer location based on the customer location information collected via a plurality of sensors.

3. The method of claim 2, wherein the plurality of sensors comprise a plurality of sensors forming a plurality of geofences.

4. The method of claim 2, wherein the plurality of sensors comprise an indoor positioning system (“IPS”).

5. The method of claim 2, wherein the plurality of sensors comprise a plurality of cameras coupled to a processor configured for facial recognition.

6. The method of claim 2, wherein determining the customer location comprises determining the customer location in a multilevel space.

7. The method of claim 2, further comprising:
receiving a request at a physical access control from a user token for access to an access-controlled area; and
determining to grant access via the physical access control based at least in part on the token and the determined customer location.

8. The method of claim 7, wherein the token comprises an application running on a customer smartphone.

9. The method of claim 7, wherein the request at the physical access control is received directly from the user token via a wireless communication protocol.

10. The method of claim 9, wherein the wireless communication protocol comprises at least one of: Bluetooth; NFC; or Zigbee.

11. The method of claim 7, wherein the plurality of sensors comprise at least one sensor in the access-controlled area.

12. The method of claim 11, wherein the at least one sensor comprises at least one of: a light detection and ranging (“LiDAR”) sensor; an ultrasound sensor; or an ultrasonic sensor.

13. The method of 11, further comprising controlling an attribute of the access-controlled area via the token.

14. The method of claim 2, wherein the recommendation is generated based on an additional attribute of the customer detected by at least one of the plurality of sensors.

15. The method of claim 14, further comprising selecting the autonomous vehicle for delivery of the physical item.

16. The method of claim 15, wherein the autonomous vehicle is selected based on at least one item attribute of the physical item.

17. The method of claim 15, wherein the autonomous vehicle comprises a camera.

18. The method of claim 17, wherein the autonomous vehicle is configured to identify the customer via facial recognition of an image generated by the camera.

19. The method of claim 15, wherein the autonomous vehicle is configured to identify the customer based on at least one communication between the autonomous vehicle and a user token.

20. The method of claim 15, wherein the autonomous vehicle comprises a temperature-controlled chamber configured to hold the physical item.

21. The method of claim 1, wherein the customer information is collected via AI agent-to-agent communication.

22. The method of claim 1, wherein the customer information is collected via communication with an AI agent.

23. The method of claim 22, wherein the AI agent comprises a system AI agent.

24-43. (canceled)
